(19) United States
(12) Patent Application Publication
(10) Pub. No.: US 2015/0381593 A1
(43) Pub. Date: Dec. 31, 2015

(54) PRIVILEGED ACCESS GATEWAY FOR ACCESSING SYSTEMS AND/OR APPLICATIONS

(71) Applicant: International Business Machines Corporation, Armonk, NY (US)

(72) Inventors: Chee Meng Low, Singapore (SG); Key Tiong Tan, Singapore (SG); Cy Boon Teoh, Singapore (SG)

(21) Appl. No.: 14/317,072

(22) Filed: Jun. 27, 2014

(51) Int. Cl. H04L 29/06

(52) U.S. Cl. CPC H04L 63/08

(57) ABSTRACT

Access to secured access systems and/or applications is provided to an authorized user through an access manager. The access manager manages access credentials for the authorized user such that the user is only authenticated by the access manager. The access manager communicates with the secured access applications and/or systems on behalf of the authorized user. Additional security features provide for the access manager to control the flow of information, from the secured access areas to the authorized user, according to the user's specified level of authorization.

### FIELD OF THE INVENTION

The present invention relates generally to the field of identity management, and more particularly to privileged identity management.

### BACKGROUND OF THE INVENTION

Privileged identity management (“PIM”) is a domain within identity management that deals with management and monitoring of privileged IDs. Currently, most PIM solutions revolve around the concept of shared IDs. Here, managed systems maintain a credential vault (“CV”) of the credentials (username and password) of shared privileged IDs (e.g. “root” or root-like accounts) on various managed systems (e.g. Linux hosts, Windows hosts, network appliances, database applications, or enterprise resource planning applications) and provide checkout-checkin (“COCI”) facilities for privileged users of such IDs during short-term use. (Note: the term(s) “LINUX” and/or “WINDOWS” may be subject to trademark rights in various jurisdictions throughout the world and are used here only in reference to the products or services properly denominated by the marks to the extent that such trademark rights may exist.)

Typically, PIM solutions provide two additional features for added security and user-convenience: (i) when a user indicates he wants to access a certain system, the PIM solution would automatically checkout an appropriate ID and single sign-on (auto-logon) to the system with the ID, such that the user never sees the password (user cannot use the ID without the assistance of the PIM solution) and (ii) maintain a record of user's activities performed in that privileged session. This ensures individual accountability, even though each privileged ID is shared and used by different users at different periods of time, as one can always consult the PIM audit logs to find out what specific users used a specific ID at a specific time and what they did with that ID.

These PIM features are typically implemented through one of two alternative methods. The first method involves the installation of a server-side agent on each managed resource. This agent would authenticate the user with his or her own enterprise credentials, then checkout a privileged ID (appropriate for the target use of the managed system) from the CV, and use this ID to auto-logon to an interactive session with the managed system. When the session is terminated, the agent will check the ID back into the CV so that the ID becomes available to the next user.

Alternatively, the second method involves the use of a client-side agent that integrates with application clients (e.g. remote desktop protocol, puTTy, etc.) to perform the automatic COCI to the managed system with a shared ID. The client-side agent can be deployed onto the user's individual machine, or onto a virtual desktop hosted in a virtual desktop infrastructure or terminal server environment. Another variation involves having a web portal whereby users download applets that act as clients for remote desktop protocol (RDP), secure shell (SSH) protocol, etc., and the web portal automates the initial logon into these clients with IDs checked-out from the CV.

### SUMMARY

Embodiments of the present invention disclose a method, computer program product, and system for providing privileged identity management. A first computer system receives a command from a client computer for a target computer. The first computer system determines a credential based on the target computer. The first computer system communicates the command and the credential to the target computer.

### BRIEF DESCRIPTION OF THE SEVERAL VIEWS OF THE DRAWINGS

FIG. 1 is a schematic view of a first embodiment of a system according to the present invention;

FIG. 2 is a flowchart showing a method performed, at least in part, by the first embodiment system;

FIG. 3 is a schematic view of a machine logic (for example, software) portion of the first embodiment system;

FIG. 4 is a flowchart showing a method performed, at least in part, by a second embodiment of a system according to the present invention; and

FIG. 5 is a schematic view of the second embodiment system for performing at least some of the method shown in FIG. 4.

### DETAILED DESCRIPTION

Access to secured access systems and/or applications is provided to an authorized user through an access manager. The access manager manages access credentials for the authorized user such that the user is only authenticated by the access manager. The access manager communicates with the secured access applications and/or systems on behalf of the authorized user. Additional security features provide for the access manager to control the flow of information from the secured access areas to the authorized user according to the user's specified level of authorization.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

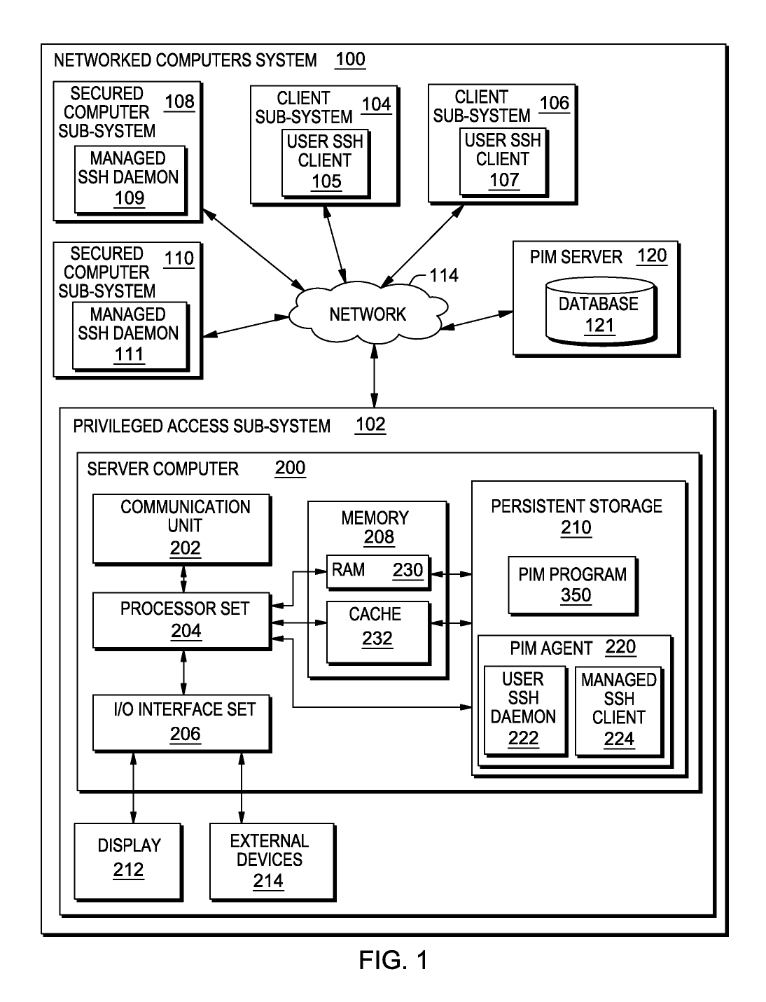

The present invention will now be described in detail with reference to the Figures. FIG. 1 is a functional block diagram illustrating various portions of networked computers system 100, in accordance with a first embodiment of the present invention, including: privileged access sub-system 102; client sub-systems 104, 106; user secure shell (SSH) clients 105, 107; secured computer sub-systems 108, 110; managed SSH daemons 109, 111; communication network 114; privileged identity management (PIM) server 120; database 121; server computer 200; communication unit 202; processor set 204; input/output (I/O) interface set 206; memory device 208; persistent storage device 210; display device 212; external device set 214; PIM agent 220, user SSH daemon 222, managed SSH client 224; random access memory (RAM) devices 230; cache memory device 232; and PIM program 350.

Privileged access sub-system 102 is, in many respects, representative of the various computer sub-system(s) in the present invention including client sub-systems 104, 106, secured computer sub-systems 108, 110 and PIM Server 120. Accordingly, several portions of privileged access sub-system 102 will now be discussed in the following paragraphs.

Privileged access sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. PIM Program 350 is a collection of machine readable instructions and/or data that is used to create, manage, and control certain software functions that will be discussed in detail, below.

Secured computer sub-system 108 may be any of the various managed systems discussed previously, e.g. Linux hosts, Windows hosts, network appliances, database applications, or enterprise resource planning applications. In an alternative embodiment, secured computer sub-system 108 is any system that requires the use of COCI or Single Sign On (“SSO”) facilities.

Privileged access sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Privileged access sub-system 102 is shown as a block diagram with many double arrows. These double arrows (no separate reference numerals) represent a communications fabric, which provides communications between various components of privileged access sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer readable storage media. In general, memory 208 can include any suitable volatile or non-volatile computer readable storage media. It is further noted that, now and/or in the near future: (i) external device(s) 214 may be able to supply, some or all, memory for privileged access sub-system 102; and/or (ii) devices external to privileged access sub-system 102 may be able to provide memory for privileged access sub-system 102.

In various embodiments, client sub-systems 104, 106, secured computer sub-systems 108, 110, and PIM server 120 includes a laptop, tablet, or netbook personal computer (PC), a desktop computer, a personal digital assistant (PDA), a smart phone, or any programmable electronic device capable of communicating with each computing device within networked computer system 100. Alternatively, PIM server 120 can be found on privileged access sub-system 102. In an alternative embodiment, secured computer sub-systems 108 is an application, or program, that runs on client sub-systems 104 and/or privileged access sub-system 102.

Database 121 resides on PIM server 120. In another embodiment, database 121 may reside on privileged access sub-system 102, or any other location that is accessibly by PIM agent 220 via network 114. A database is an organized collection of data. Data found in a database is typically organized to model relevant aspects of reality in a way that supports processes requiring the information found in the database. Database 121 can be implemented with any type of storage device capable of storing data that may be accessed and utilized by privileged access sub-system 102, such as a database server, a hard disk drive, or a flash memory. In other embodiments, database 121 can represent multiple storage devices within PIM server 120. Database 121 may include a credential vault (“CV”) (not shown) of the credentials (username and password) of shared privileged IDs (e.g. “root” or root-like accounts) for various managed systems that can be provided for checkout-checkin (“COCI”) facilities for privileged users. Additionally, database 121 may include audit logs of user's actions in, for example, secured computer sub-system 108 via client sub-system 104. Database 121 may also include information related to recognition of user commands for access to various managed systems/contexts, e.g., ssh, scp, wasadmin, dbs, su, or arbitrary scripts.

PIM program 350 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

PIM program 350 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer readable storage media such as, for example, thumb drives, portable optical or magnetic disks, and memory cards. Software and data used to practice embodiments of the present invention, for example, PIM program 350, can be stored on such portable computer readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

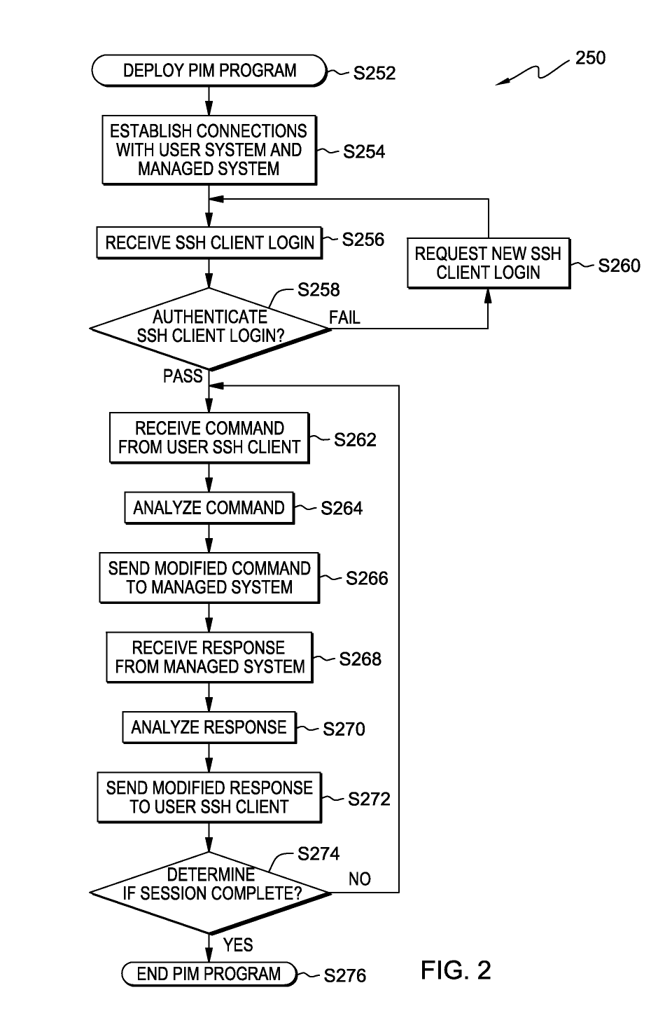

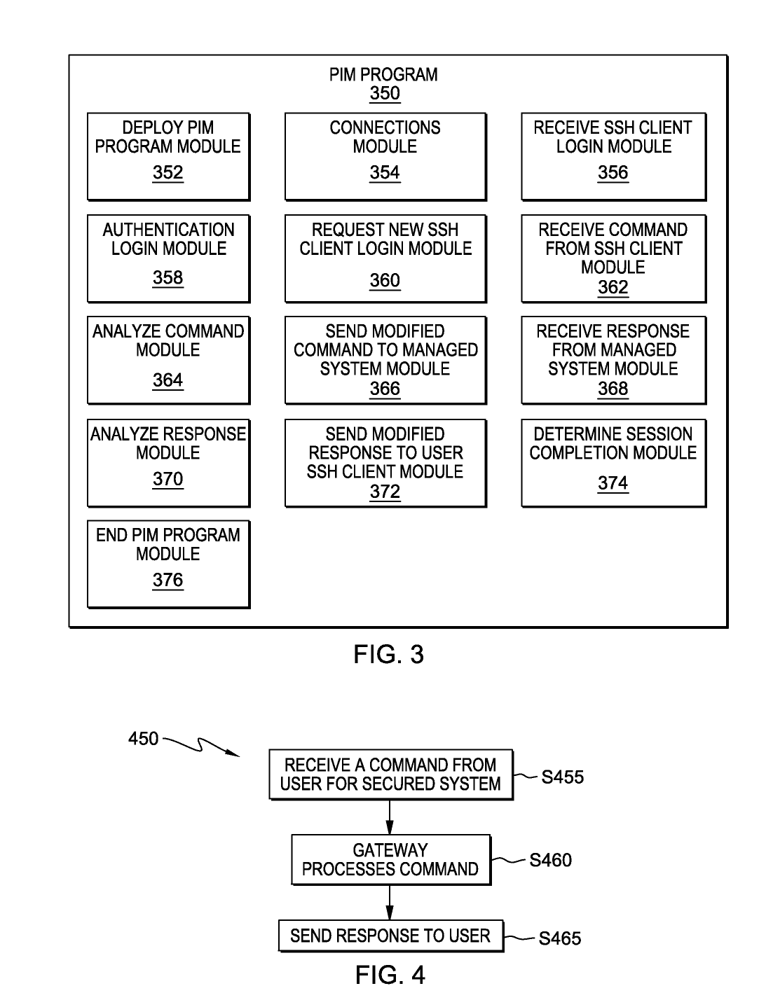

FIG. 2 shows flowchart 250 depicting a first method according to the present invention. FIG. 3 shows PIM program 350 for performing at least some of the method steps of flowchart 250. This method and associated software will now be discussed, over the course of the following paragraphs, with extensive reference to FIG. 2 (for the method step blocks) and FIG. 3 (for the software blocks).

PIM Program 350 may be implemented on any operating system, for example: the operating system active on a partition, on the hardware management console, on a network switch, or on a storage controller. Additionally, an embodiment of PIM program 350 is setup for the secure shell (SSH) protocol. Alternatively, PIM program 350 can be applied to any other network protocols known in the art including, but not limited to: hypertext transfer protocol (HTTP); and remote desktop protocol (RDP).

Processing begins at step S252, where deploy PIM program module 352 deploys PIM program 350. In this example, deploy PIM program module 352 detects an input from a user indicating that the user would like to execute PIM program 350. Alternatively, this step may occur by an automated process after any number of Information Technology (IT) services are initiated or completed. In one embodiment, this step may occur after the initial setup of IT services on privileged access sub-system 102. Alternatively, this step may occur concurrently with S254, upon privileged access sub-system 102 connecting to any of the clients or systems.

Deploy PIM program module 352 deploys PIM agent 220 stored on persistent storage 210. PIM agent 220 manages communications between an authorized user and one, or more, secured access systems and/or applications. For example, client sub-system 104 accesses secured computer sub-system 108 via PIM agent 220. PIM agent 220 includes user SSH daemon 222 and managed SSH client 224. User SSH daemon 222 connects with any authorized user via, for example, user SSH client 105 to establish secured communications between, for example, client 104 and PIM agent 220. Managed SSH client 224 connects PIM agent 220 with any systems and/or applications, for example, PIM agent 220 communicates with secured computer sub-system 108 via managed SSH daemon 109 through managed SSH client 224.

Secure shell (SSH) is a cryptographic network protocol for: (i) secure data communication; (ii) remote command-line login; (iii) remote command execution; and/or (iv) other secure network services between two networked computers. SSH protocol connects, via a secure channel over an insecure network, a server and a client running SSH server and SSH client programs, respectively. For example, SSH client program includes user SSH client 105 and managed SSH client 224, and SSH user program includes manages SSH daemon 109 and user SSH daemon 222. Alternatively, any of the client or daemon setups found in the embodiments of this specification can be in any number or form of SSH server or SSH client programs that provide secure shell (SSH) communication.

Processing proceeds to step S254, where connections module 354 establishes connections between client/PIM agent and system/PIM agent. Additionally, connections module 354 can also establish connections between PIM server 120 and PIM agent 220. PIM agent 220 inspects, intercepts, and modifies the traffic that flows between, for example, client sub-system 104, secured computer sub-system 108, and PIM server 120. In an embodiment, client sub-system 104 and secured computer sub-system 108 cannot directly connect and communicate with each other, but may communicate through privileged access sub-system 102. Client sub-system 104 and secured computer sub-system 108 cannot directly connect and communicate with PIM server 120 to gain access to credentials database 121, but only the privileged access sub-system 102 communicates with PIM server 120.

Processing proceeds to step S256, where receive SSH client login module 356 receives a login request from a user utilizing client sub-system 104 via user SSH client 105. A login request includes a user entering his or her credentials, including a user's login identification and specific password associated with the user's identification. Alternatively, the login request may occur with the use of a software token. A software token is a type of two-factor authentication security device that may be used to authorize the use of computer services. Software tokens can be stored on a general-purpose electronic device such as a desktop computer, laptop, PDA, or mobile phone and can be duplicated. This token may be received by the user in the form of an encrypted communication, hyperlink, or any other method suitable for the foregoing intended use as known in the art. The software token is activated by the user. Step S256 authenticates the user with client sub-system 104, where no authentication is determined between client sub-system 104 and secured computer sub-system 108.

Processing proceeds to decision block S258, where authentication login module 358 authenticates the login identification and password combination received in the previous step. In this example, login identification and password combination (also referred to as access credentials, or, simply, credentials) is compared to corresponding information on database 121. Alternatively, the credentials are authenticated with information found on a client sub-system, such as client sub-system 104 or any other location that is accessible via network 114. If the login request is authenticated, in other words if the credentials entered match what is found on database 121, the user passes the authentication process (decision block S258, Pass branch) and processing proceeds to step S262. Alternatively, the login request may fail (decision block S258, Fail branch). In that case, processing proceeds to S260. Alternatively, where a software token is used, decision block S258 is skipped and proceeds directly to step S262.

If there was an unsuccessful authentication login (decision block S256, Fail branch), processing proceeds to step S260, where request new SSH client login module 360 requests a new set of login credentials from the user. This occurs in the instance of a failed authentication login attempt as discussed in the previous step. Processing then returns to step S256.

Responsive to a passing authentication login attempt (decision block S256, Pass branch), processing proceeds to step S262, where receive command from SSH client module 362 receives a command, via user SSH daemon 222, from a user operating user SSH client 105 via client 104. In this example, the command is for an operation to be performed on or by secure computer sub-system 108. Alternatively, the command is for an operation related to PIM server 120, such as COCI facilities for users to checkout IDs for short-term use via database 121.

Processing proceeds to step S264, where analyze command module 364 analyzes the command that is received from a user in step S262. The analyze command module 364 determines what information, input by the user in step S262, should be forwarded to either PIM server 120 or secured computer sub-system 108. For example, if the user has requested to logon to secured computer sub-system, analyze command module 364 retrieves the login credentials from database 121 via PIM server 120. The user may not see the login credentials that are specific to secured computer sub-system 108. In this case, upon checking out the credentials, analyze command module 364 begins recording commands that are executed across the command shells. In other words, all actions performed by the user from that time forward, even when using login credentials from the PIM server 120, are recorded for review at a later time. Since PIM program 350, via PIM agent 220, has full visibility into what a user sees and types into user SSH client 105, PIM agent 220 is fully capable of recording all the commands entered by user, as well as all the resulting outputs that are displayed back to the user. These records can be saved to the PIM server 120 in database 121 for later review by security administrators and auditors.

Processing proceeds to step S266, where send modified command to managed system module 366 sends a modified user command to secured computer sub-system 108. Send modified command to managed system module 366 utilizes managed SSH client 224 to send the command to managed SSH daemon 109, to be received by secured computer sub-system 108. In this example, the send modified command to managed system module 366 adds the checked-out credentials to the original command from the user via user SSH client 105. For example, when the user wishes to logon to a secured computer sub-system 108, the user needs only to log in to user SSH client 105. PIM agent 220 checks out an available shared ID for secured computer sub-system 108 from PIM server 120, inserts the shared ID and password that is checked out, and relays the now-modified command to secured computer sub-system 108. In this example, the user will neither see the password prompt from secured computer sub-system 108 nor the actual password used because the PIM agent 220 will not echo these back to user SSH client 105, as discussed previously. Steps S264 and S266 may be performed concurrently. In an alternative embodiment they may be combined into one step.

Processing proceeds to step S268, where receive response from managed system module 368 receives a response, via managed SSH client 224, from secured computer sub-system 108 via managed SSH daemon 109. In this example, secured computer sub-system 108 will have processed the modified command from S266. Accordingly, a response is returned by secured computer sub-system 108 for the user of client sub-system 104. PIM Agent 220 then intercepts the returned response via managed SSH client 224. For example, secured computer sub-system 108 returns a response to PIM Agent 220 that intends to notify a user that they are now logged into secured computer sub-system 108, and that secured computer sub-system 108 has given the user a specific identification name for that session.

Processing proceeds to step S270, where analyze response module 370 analyzes the command that is received from secured computer sub-system 108 in step S268. Step S270 is similar to step S264 in that analyze response module 370 performs functions similar to analyze command module 364. The analyze response module 370 determines what information, sent from secured computer sub-system 108 and received by PIM agent 220, should be forwarded to user of client sub-system 104 via user SSH client 105. For example, if secured computer sub-system 108 returns a user-specific identification name for the current session on secured computer sub-system 108 after the login credentials are verified, PIM agent 220 removes the user-specific identification name before the response is sent. In that way, the user is not privy to the user-specific identification name. In this example, for security reasons, the user does not know their own secured computer sub-system 108 user-specific identification name. This allows secured computer sub-system 108 and the user specific identification name to remain private, that is, isolated, from the user of client sub-system 104. Therefore, the user cannot perform functions on secured computer sub-system 108 if they were able to bypass PIM agent 220. For example, if a user were to hack into secured computer sub-system 108 to perform malicious functions on secured computer sub-system 108 without the knowledge of the security system, the user would not have the user-specific identification name required to complete the malicious functions. Additionally, because PIM program 350, via PIM agent 220, has full visibility of what is sent from secured computer sub-system 108 to client sub-system 104, PIM agent 220 is capable of recording all of the commands that are returned by secured computer sub-system 108 and sent back to the user. In an embodiment of the present invention, these records are saved to the PIM server 120 in database 121 for later review by security administrators and/or auditors.

Processing proceeds to step S272, where send modified response to user SSH client module 372 sends a modified response to client sub-system 104. Send modified response to user SSH client module 372 utilizes user SSH daemon 222 to send the modified response to user SSH client 105, to be received by client sub-system 104. In this example, the send modified response to user SSH client module 372 removes the required COCI credentials from the original response from the secured computer sub-system 108 via managed SSH daemon 109. For example, when the secured computer sub-system 108 sends a response to a user to a command received, PIM agent 220 returns the shared ID for secured computer sub-system 108 to PIM server 120, and relays the now-modified response to client sub-system 104. In this example, the user will neither see the password returned from secured computer sub-system 108 nor the actual login used because the PIM agent 220 will not echo these back to user SSH client 105, as discussed previously. Steps 270 and S272 may be performed concurrently. In an alternative embodiment they may be combined into one step.

Processing proceeds to decision block S274, where determine session completion module 374 determines if the session is complete. In this embodiment, determine session completion module 374 determines, by requesting a response from user via client sub-system 104, if there are any additional commands that will be received from a user via client sub-system 104. For example, if a user, via client sub-system 104, indicates that the session is complete (decision block S274, yes branch), then processing ends at step S276, where PIM program 350 terminates the process. Alternatively, if the user, via client sub-system 104, indicates that the session is not complete, that is, there are still commands to be processed (decision block S274, no branch), then processing returns to step S262, where a new command is received from user SSH client 105. Alternatively, step S274 is skipped and processing returns to step S262 unless there is a positive indication by the user, via client sub-system 104, that the session is complete. Alternatively, in step S264, PIM program 350 determines, based on what the user wanted to complete initially, that the user shall only be able to enter a certain number of commands and receive a certain number of responses from secured computer sub-system 108. Accordingly, when the final action is performed, processing ends at step S276, where PIM program 350 terminates the process.

Processing ends at step S276, where end PIM program module 376 terminates PIM program 350. In other words, the PIM program 350 has finished examining all commands between client sub-system 104 and secured computer sub-system 108 and can now end execution. For example, a user of client sub-system 104 finishes performing all IT related tasks that needed to be completed, so the connection between client sub-system 104, via user SSH client 105, and secured computer sub-system 108, via managed SSH daemon 109, is severed. All COCI are completed and returned to their proper database, etc. Accordingly, all work is completed by PIM program 350.

Some embodiments of the present invention provide for privileged users to log on to the PIM agent 220. PIM agent 220 intercepts all network traffic between client sub-system 104 and secured computer sub-system 108 that the user of client sub-system 104 visits. PIM agent 220 performs the necessary tasks to assist the user with access to various targets, enforces the policies that govern the use of privileged IDs, and records the trail of commands executed. PIM agent 220 has full control over which user inputs to pass on to the secured computer sub-system 108, and full control over what outputs from secured computer sub-system 108 to display back to the user of client sub-system 104. PIM agent 220 is able to modify/adorn commands entered by user of client sub-system 104 before passing the commands on to secured computer sub-system 108, as well as selectively blocking or replacing any outputs from secured computer sub-system 108 before they are passed on to the user of client sub-system 104. For example, upon determining “ssh” command to another host apphost23 with a checked-out ID “dbadm1” is successful, PIM agent 220 can display a message “Successfully logged onto apphost23 with ID dbadm1” to the user. The user will not know whether the message is from PIM agent 220 or from apphost.

In another example, when the user wishes to logon to a system “apphost23”, the user just needs to type “ssh apphost23” into user SSH client 105 into the command shell. PIM agent 220 will, behind the scenes, checkout an available shared ID (say, “sysadm”) from database 121, insert the command “ssh −1 sysadm apphost23”, and then inject the password into the resulting “password:” prompt from the secured computer sub-system 108. The user will neither see the password prompt or the actual password since PIM agent 220 will not echo these back to client sub-system 104. Likewise, if user of client sub-system 104 wishes to logon to a command line application like “wsadmin”, he just needs to type “wsadmin” on the User SSH client, 105 and PIM agent 220 can transparently logon user into the “wsadmin” system with a shared ID checked out from database 121.

To support PIM agent 220 operations on arbitrary commands, PIM agent 220 can be configure with “profiles”, stored in database 121, of expected commands, command-line apps, and scripts that teach the PIM agent 220 how to handle such command. For example, the profile for “ssh” would specific how to identify the target system (e.g. “apphost23”) from the entered command, how to insert the user name (e.g., via a “−1” flag) and when/how to insert the password (e.g., after a “password:” prompt is returned). This way, PIM agent 220 can be easily configured to handle COCI and SSO into arbitrary commands. In a SSO case, PIM agent 220 would be fetching the required credentials from a credential wallet specific to a user and this credential wallet may be maintained on database 121.

In addition, since PIM agent 220 has full visibility into what a user of client sub-system 104 sees and types into user SSH client 105, PIM agent 220 is fully capable of recording all of the commands entered by the user, as well as the resulting outputs displayed back to him. These records can be saved to database 121 for later review by security administrators and auditors if needed.

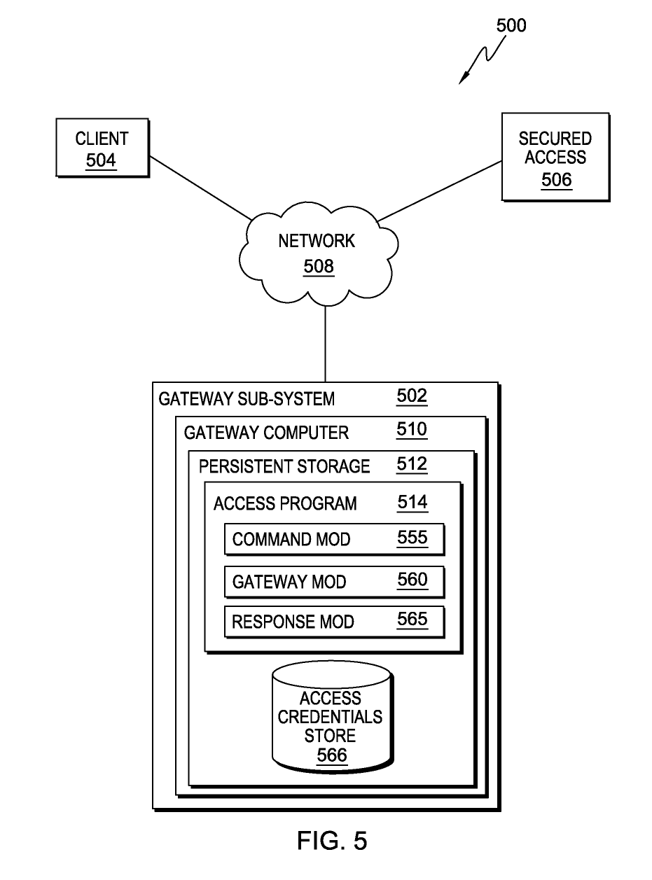

FIG. 4 shows flowchart 450 depicting a second method according to the present invention. FIG. 5 shows networked computers system 500, in accordance with a second embodiment of the present invention, for performing at least some of the method steps of flowchart 200. Networked computers system 500 is much like networked computers systems 100, presented above. For example, client sub-system 504, secured access sub-system 506, and network 508 are much like client sub-system 104, secured computer sub-system 108, and network 114 respectively. However, persistent storage 512 in gateway computer 510 of gateway sub-system 502 includes different modules: access program 514, command module 555, gateway module 560, response module 565, and access credentials store 566. This method and associated software will now be discussed, over the course of the following paragraphs, with extensive reference to FIG. 4 (for the method step blocks) and FIG. 5 (for the software blocks).

Processing begins at step S455, where command module 555 receives a command from a user directed to secured access sub-system 506. In this example, the user is authenticated for sending a command through the command module to the secured access sub-system. Alternatively, each time a command is issued by a user on client sub-system 504, or other sub-systems (not shown), command module authenticates the user for sending commands to the secured access sub-system. Alternatively, the user is authenticated for communication with a secured access sub-system based on the identity of the client sub-system in use, such as client sub-system 504.

Processing proceeds to step S460, where gateway module 560 processes the received command. Examples of various commands are discussed at length above. One example of a command that may be received is the “wsadmin” command, which is a tool for performing systems administration on all the artifacts in a commercially available web application server cell. This command may be used to execute scripts and/or commands to perform administrative tasks such as: (i) application deployment; (ii) configuration changes; (iii) run-time monitoring of a web application server; and/or (iv) run-time control of a web application server.

Processing the received command involves a number of sub-steps that are described in the following paragraphs. When a command is received from command module 555, the gateway module fetches credentials from access credentials store 566 for the corresponding secured system, for example, secured sub-system 506. Continuing with the example above, with an effective session in place for the user, the command “wsadmin” is submitted without credentials for access to the secured access sub-system. In this example, the gateway module inspects the command to determine the target sub-system and whether credentials are provided. Alternatively, the user is unable to enter any secured access credentials, so the gateway module responds to receiving a command by simply identifying the target sub-system. While only one secured sub-system is shown in the illustration, many commercial embodiments of the present invention will include several secured access sub-systems that may include layers of security within each sub-system.

Having determined the target secured access sub-system, gateway program 560 embellishes the received command with the access credentials fetched from access credentials store 566. The embellished command is then forwarded to the target secured access sub-system. In some embodiments, as described above, the embellished command is sent to the secure sub-system via a managed host application. However the embellished command is sent, the secure sub-system executes the command as normal and returns the response. Oftentimes a response is returned when the command executes. For example, a command to return specified data would cause the secured system to return the requested data. Gateway module 560 receives any corresponding response from the secured sub-system.

Processing proceeds to step S465, where response module 565 sends a response to the user. In this example, the response module receives clearance data for the commanding user so that only response materials for which the commanding user is authorized to receive pass through to the user. That is, some responsive data may not be received by the user if the user is not authorized to receive the data. Alternatively, the response module receives the response from the secured sub-system and prepares and/or formats the response for viewing by the user.

In an alternative embodiment, the user can inject dialog or additional commands in response to a prompt from PIM agent 220 in order to re-construct/modify a command to send to the target system. PIM agent 220 can request additional information, in the form of dialog or additional commands, from the user to send to secured computer sub-system 108. For example, the user can request SSH login to target system apphost23. PIM agent 220 intercepts this request, and in response, asks the user if they would like to checkout a shared ID for apphost. The user confirms that they would like to checkout a shared ID. PIM agent 220 intercepts this response, and then prompts the user to provide a justification for checking out a shared ID. The user provides a justification that can include “To restart data base service.” PIM agent 220 intercepts this response and logs the user onto apphost23 with a shared ID if the justification is approved for checkout of a shared ID. Alternatively, PIM agent 220 will log the user into apphost23 regardless of the justification provided and will record the justification for later review, for example when reviewing PIM audit logs.

Some embodiments of the present invention may include one, or more, of the following features, characteristics and/or advantages: (i) secure and convenient access into multiple systems and applications with privileged credentials, by a privileged access gateway (PAG) between the user's client applications and the managed systems; (ii) provides for inspection, interception, and modification of traffic between user's client applications and managed systems; (iii) intelligence is added into the SSH daemon to implement PIM requirements underneath the covers; (iv) use of an SSH gateway to transparently log users on, to enter commands and command shells of various target secure systems with credentials managed by a PIM system; (v) use of a customized SSH daemon to inspect and adorn user input commands to achieve auto-logon (or single sign-on) into the target system/application; (vi) use of a customized SSH daemon to filter outputs displayed to user; (vii) method of supporting auto-logon single-sign-on (SSO) into nested and arbitrary command shells and applications on one or multiple hosts; (viii) provides for using customizable “profiles” to define necessary info for each secure command/application; (ix) method of on-demand and contextual communication between the user and the SSH daemon (when the PIM/SSO agent needs to ask user for inputs) (when the user needs to launch the PIM agent to make specific requests); (x) method of manual checkout of credentials for injection into shell commands without revealing the password to the user; (xi) use of SSH gateway to transparently log users into commands and command shells of various target systems with credentials managed by an enterprise single-sign-on (E-SSO) system; (xii) method of capturing new credentials (of personal accounts) upon first use and updating the credentials into the user's E-SSO credential wallet; and/or (xiii) recording all commands and outputs (adorned with meta-data such as current “state”) as seen by the user while accessing one or more systems/applications from the user's SSH client.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User: includes, but is not necessarily limited to, the following: (i) a single individual human; (ii) an artificial intelligence entity with sufficient intelligence to act as a user; (iii) a subscriber and/or (iv) a group of related users.

Computer: any device with data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A method for providing privileged identity management, the method comprising:
receiving a command from a client computer for a target computer;
generating a modified command, wherein the modified command includes a login credential for the target computer; and
communicating the modified command to the target computer;
wherein:
at least the receiving, generating, and communicating step is performed by computer software running on computer hardware.

2. The method of claim 1, further comprising:
responsive to receiving the command from the client computer for the target computer, requesting an input from the client computer, wherein the input includes at least one of the following: justification for sending the command and confirmation to proceed with communicating the command.

3. The method of claim 1, further comprising:
receiving a response to the modified command from the target computer;
generating a modified response, wherein the modified response does not include the login credential for the target computer; and
communicating the modified response to the client computer;
wherein:
at least the receiving, generating, and communicating step is performed by computer software running on computer hardware.

4. The method of claim 1, further comprising:
receiving a response to the modified command from the target computer; and
determining a portion of the response to send to the client computer.

5. The method of claim 1, wherein generating the modified command is based, at least in part, on a profile for the target computer.

6. The method of claim 3, further comprising:
recording a command or modified response communicated between the client computer and the target computer.

7. The method of claim 3, wherein the modified response does not contain any of the response received from the target computer.

8. The method of claim 3, wherein generating the modified response is based, at least in part, on a profile for the client computer.

9. The method of claim 5, wherein the profile includes information for command modification, command-line applications modification, and command line script modification.

10. The method of claim 8, wherein the profile includes information for command modification, command-line applications modification and command line script modification.

11. A computer program product for providing privileged identity management, the computer program product comprising:
one or more computer readable storage media; and
program instructions stored on the one or more computer readable storage media, the program instructions comprising:
program instructions to receive a command from a client computer for a target computer;
program instructions to generate a modified command, wherein the modified command includes a login credential for the target computer; and
program instructions to communicate the modified command to the target computer.

12. The computer program product of claim 11, further comprising program instructions, stored on the one or more computer readable storage media, to:
receive a response to the modified command from the target computer;
generate a modified response, wherein the modified response does not include the login credential for the target computer; and
communicate the modified response to the client computer.

13. The computer program product of claim 11, further comprising program instructions, stored on the one or more computer readable storage media, to:
receive a response to the modified command from the target computer; and
determine a portion of the response to send to the client computer.

14. The computer program product of claim 12, wherein the modified response does not contain any of the response received from the target computer.

15. The computer program product of claim 12, further comprising program instructions, stored on the one or more computer readable storage media, to:
record a command or modified response communicated between the client computer and the target computer.

16. A computer system for providing privileged identity management, the computer system comprising:
one or more computer processors;
one or more computer readable storage media; and
program instructions, stored on the one or more computer readable storage media for execution by at least one of the one or more computer processors, the program instructions comprising:
program instructions to receive a command from a client computer for a target computer;
program instructions to generate a modified command, wherein the modified command includes a login credential for the target computer; and
program instructions to communicate the modified command to the target computer.

17. The computer system of claim 16, further comprising program instructions, stored on the one or more computer readable storage media for execution by at least one of the one or more computer processors, to:
receive a response to the modified command from the target computer;
generate a modified response, wherein the modified response does not include the login credential for the target computer; and
communicate the modified response to the client computer.

18. The computer system of claim 16, further comprising program instructions, stored on the one or more computer readable storage media for execution by at least one of the one or more computer processors, to:
receive a response to the modified command from the target computer; and
determine a portion of the response to send to the client computer.

19. The computer system of claim 17, wherein the modified response does not contain any of the response received from the target computer.

20. The computer system of claim 17, further comprising program instructions, stored on the one or more computer readable storage media for execution by at least one of the one or more computer processors, to:
record a command or modified response communicated between the client computer and the target computer.
